(19) United States
(12) Patent Application Publication
(10) Pub. No.: US 2007/0244731 A1
(43) Pub. Date: Oct. 18, 2007

(54) System and Method for Mobile Virtual Mobile Ticketing

(76) Inventors: William J. Barhydt, Los Gatos, CA (US); Sanjeev Bhalla, Sunnyvale, CA (US); Julian Hardy, London (GB); Karl Stewart, San Jose, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/695,925

(22) Filed: Apr. 3, 2007

Related U.S. Application Data
(60) Provisional application No. 60/788,929, filed on Apr. 3, 2006.

(51) Int. Cl. G06Q 10/00

(52) U.S. Cl. 705/5

(57) ABSTRACT

Provided herein are systems and methods for allowing mobile users to join a virtual line or queue for high demand tickets to an event. In an embodiment, users pay a small fee to join the virtual line or queue. After the users join the virtual line, the tickets to the event are allocated to the users in the virtual line based on an allocation policy set by the ticket distributor. After the allocation has been made, the users are notified of the allocation decision and each user that has been allocated a ticket is given an opportunity to purchase the ticket, e.g., within a purchase fulfillment period. In an embodiment, a user may purchase virtual tickets to join the virtual line or queue using his/her mobile phone/handset. In this embodiment, the user may be charged through his/her mobile carrier for the purchase of a virtual ticket.

### RELATED APPLICATION INFORMATION

This application claims the benefit of U.S. Provisional Application Ser. No. 60/788,929, filed on Apr. 3, 2006.

### FIELD OF THE INVENTION

The invention relates to systems and methods for allowing mobile users to join a virtual line or “queue” for high demand tickets by paying a fee to join the virtual line.

### BACKGROUND INFORMATION

Tickets for certain attractive events such as popular concerts, sporting events, and the like are in high demand and often sell out soon after they are made available. People often stand in line for many hours or even days to get such high demand tickets.

### SUMMARY

Provided herein are systems and methods for allowing mobile users to join a virtual line or queue for high demand tickets to an event.

In an embodiment, users pay a small fee to join the virtual line or queue. After the users join the virtual line, the tickets to the event are allocated to the users in the virtual line based on an allocation policy set by the ticket distributor. After the allocation has been made, the users are notified of the allocation decision and each user that has been allocated a ticket is given an opportunity to purchase the ticket, e.g., within a purchase fulfillment period.

In an embodiment, user may purchase virtual tickets to join the virtual line or queue using his/her mobile phone/handset. In this embodiment, a user may be charged through his/her mobile carrier for the purchase of a virtual ticket.

In other embodiments, the distributor may choose different models for offering tickets through virtual lines and allocating tickets to users in the virtual lines based on the events being ticketed. By implementing different models as descried herein, the distributor is able to tailor its offerings, generate additional revenue, and provide different and more convenient avenues to distribute tickets to its consumers.

The systems and methods provided herein advantageously allow a ticket distributor to generate addition revenue by leveraging the high demand typically associated with popular events and captures some of the revenue that is lost to scalping and other higher priced reselling.

Other systems, methods, features and advantages of the invention will be or will become apparent to one with skill in the art upon examination of the following figures and detailed description.

### BRIEF DESCRIPTION OF THE FIGURES

FIG. 1 shows a system architecture for providing mobile virtual ticketing according to an embodiment of the present invention

FIG. 2 shows an exemplary time line for purchase of a virtual ticket according to an embodiment of the present invention.

FIG. 3 shows a flowchart of a virtual ticketing process according to an embodiment of the present invention.

### DETAILED DESCRIPTION

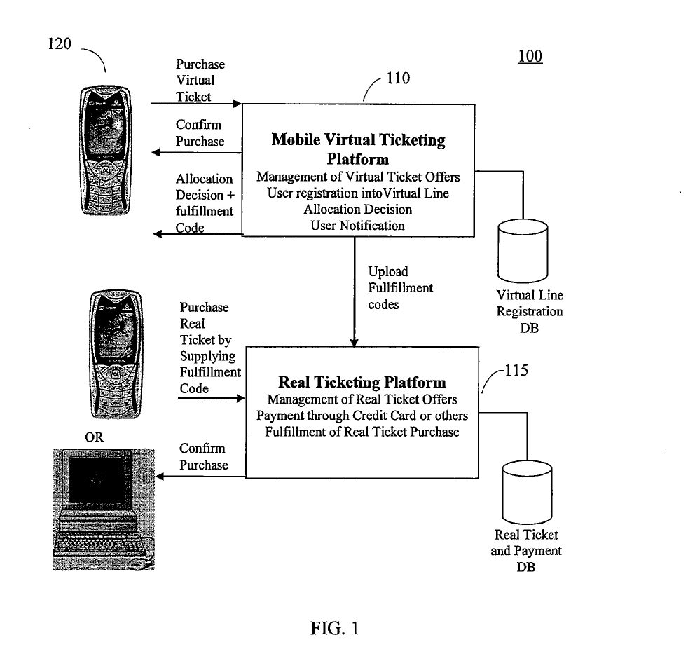

FIG. 1 shows a system architecture 100 for providing mobile virtual ticketing according to an embodiment of the present invention. The system 100 is connectable to the mobile phone/handset 120 of a user via a wireless link, and comprises a mobile virtual mobile ticketing platform 110 and a real ticketing platform 115.

A virtual ticketing process according to an embodiment of the present invention will now be described with reference to FIG. 1. The process comprises the following five steps:
1. Create an offer to join a virtual line through purchase of a virtual ticket and disseminate information about the offer, e.g., to mobile users.
2. Receive purchases of the virtual tickets, e.g., from mobile users.
3. Allocate real tickets to purchasers of the virtual tickets based on an allocation policy.
4. Notify purchasers of the allocation of real tickets and provide each purchaser that has been allocated a real ticket(s) with an opportunity to purchase the real ticket(s).
5. Purchasers that have been allocated real tickets fulfill purchase of the real tickets.

The above steps will now be described in greater detail below.

1. Creation of the Virtual Ticket Offer and Disseminating Information

The distributor of the real tickets creates a virtual ticket offer by:

a) Selecting the underlying event and the number of real tickets for the event that are available through the Virtual Ticket channel. The event may be a popular concert, sporting event, or the like.

b) Specifying the virtual ticket offer. The offer may include specifications of the following attributes:
i) Price that the users will pay for the virtual ticket, separate from the price of the underlying real ticket. For example, the price of the virtual ticket may be small, e.g., $3, compared to the price of the real ticket.
   ii) Maximum number of real tickets that can be fulfilled by one user.
   iii) Date the virtual ticket line is open and available and date the virtual ticket line closes.
   iv) When the allocation of real tickets is decided and users are notified of the allocation decision.
   v) Setting the allocation policy.
   vi) Setting the cancellation policy.

c) Selecting how the users will purchase the virtual ticket from their mobile phones, e.g., through Short Message Service (SMS), through Wireless Application Protocol (WAP) site, or through In Application distribution.

Allocation Policy

An advantage of the Virtual Ticketing Platform 110 is that different allocation policies may be used for different opportunities. Examples of allocations policies that may be used to allocate the real tickets include the following:

a) First Come First Served
In this model, similar to traditional lines in the real world, tickets are allocated in the order in which the virtual ticket entries were received by the platform, until all the real tickets allocated for the Virtual Ticket channel have been allocated. A wait-list is also created with the next entries in line in case purchases of certain allocated tickets are not fulfilled. If certain allocated tickets are not purchased, e.g., within a time period, then users in the wait-list are given an opportunity to purchase these tickets.
A disadvantage of this policy is that users who do not respond quickly will be discouraged from purchasing a virtual ticket because they may believe that all real tickets have already been distributed.

b) Random Allocation, Single Entry Per Mobile Number
In this model, all entries received between the start date and the end date of the virtual ticket offer are considered in one pool. Only one entry from one mobile number is allowed. The entries to which real tickets are allocated are randomly selected from the pool.
An advantage of this policy over the First Come First Served policy is that users can purchase real tickets without worrying whether they are already too late.

c) Random Allocation, Multiple Entries Per Mobile Number
In this model, a given mobile user may purchase multiple virtual ticket entries between the start date and the end date of the offer. Each entry is considered separately in the pool. The entries to which real tickets are allocated are randomly selected from the pool. When the random selection is made, users with multiple entries have a higher probability of getting a real ticket.
This model has the advantage of increasing the number of entries and hence the incremental revenue that is generated by the Virtual Ticket offer.

d) High Bid
In this model, users are allowed to bid for the real ticket. The allocation decision is made by ordering the bids and allocating the tickets in the order from high bid to low bid.
This model has the advantage of maximizing the total revenue produced for high demand tickets because users are allowed to bid high if they want the ticket eagerly.
This model is more complex than the other models and requires that after placing the bid the user be given information on whether the user's current bid gets him/her a ticket as of that time instance and when his/her bid has dropped out of getting the ticket because other higher bids have come in. Such information will encourage users to revise their bids as the ticket demand dynamics play out. To implement this, the Mobile Virtual Ticketing Platform 110 will implement a bidding process and run allocation model in real time and notify the users using SMS.

Cancellation Policy

In one embodiment, a cancellation policy is to not allow cancellations once a virtual ticket offer has been placed. Because it is optional for the users to fulfill the real ticket purchase if they are allocated real tickets, a cancellation policy is not required. However, in certain cases, the distributor may want to allow users the right to cancel his/her virtual ticket before the closing date of the virtual ticket offer. In such cases interfaces similar to those used to create the offer can be used to cancel it.

As an example, a distributor may decide to use Virtual Ticket for distributing 500 tickets to a Rolling Stones concert to be held on Nov. 1, 2006. The distributor elects to charge customers $3 for the Virtual ticket and limits them to a maximum of 2 tickets per customer. The allocation will be based on random allocation and multiple entries per mobile number are allowed. Virtual tickets may not be cancelled once placed. The offer is open on Aug. 1, 2006 and ends on Aug. 30, 2006.

The distributor may publicize an offer to purchase virtual tickets through various advertising channels including but not limited to posters, in store displays, web banner ads, affiliate marketing programs, etc.

2. Purchase of Virtual Ticket

A customer upon seeing an offer and becoming interested in purchasing a virtual ticket uses the mechanism made available by the distributor to purchase the virtual ticket.

This virtual ticket mechanism may be made available through either Short Message Service (SMS), or through Wireless Web (WAP site or XHTML site), or by embedding it into another wireless application.

For SMS, an SMS short code is chosen and registered with the wireless operator. To purchase a virtual ticket, the user sends a SMS message to the short code. The text of the SMS message may include the code of the virtual ticket offer as well as any special keyword that is needed if a shared short code is being used. For example, the SMS message could be “VTKT BUY RSTONE 2” to initiate purchase of a virtual ticket to buy 2 real tickets to a Rolling Stones concert.

To conform to mobile marketing guidelines in various countries the system may implement double opt-in where, in response to the incoming SMS from the user, the system sends a confirmation message of the offer that has to be acknowledged by the user. As an example, the system response could be: “To buy a virtual ticket for Rolling Stones concert on Mar. 2, 2006, reply yes to this message. You will be charged $3.” When the user replies with a “Yes” the user is charged $3 and a virtual ticket entry is created using the user's mobile number to identify the entry.

In the Wireless Web option, the distributor creates a WAP/XHTML site which shows users the offer and allows them to purchase a virtual ticket in the offer. The purchase is completed by using WAP identification and a billing service provided by the wireless operator or SMS aggregator such as IPX and mBlox. IPX and mBlox are examples of billing services that enable transactions to be billed to the user through the user's mobile carrier.

In the third option, the offer of the virtual ticket may be embedded inside an application on the mobile phone/handset, e.g., a promotion or gaming application. The application may be a J2ME or a BREW application. The application fetches the details of the offer from a backend system and display a screen to the user regarding the offer. When the user initiates the purchase, the user's mobile identity may be used to complete the purchase, similar to the mechanisms described above, by charging the user and placing the user in the virtual ticket line.

When a purchase request for a virtual ticket is received, the Mobile Virtual Ticketing Platform 110 registers the user in the ticket line using the user's mobile number as the identity for the user. The Platform 110 stores the purchase information including the purchaser's mobile number, timestamp, offer identification (ID), offer details in a database table. The Platform 110 may also send the user the allocation policy and the date when the allocation will be made.

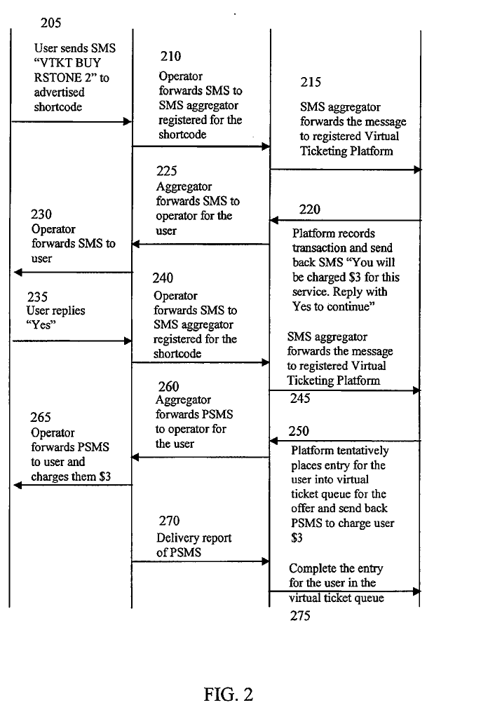

FIG. 2 shows an exemplary time line for purchase of a virtual ticket according to an embodiment of the present invention. In step 205, the user sends an SMS message “VTKT BUY RSTONE 2” to an advertised short code, e.g., a 4-6 digit code. The wireless operator forwards the SMS message to the SMS aggregator registered for the short code in step 210, and the SMS aggregator forwards the SMS message to the Virtual Ticketing Platform 110 in step 215. The Platform 110 records the transaction and sends an SMS message to the user to confirm the purchase in step 220. In this example, the message reads: “You will be charged $3 for this service. Reply with Yes to continue.” The SMS aggregator forwards the SMS message to the wireless operator in step 225, and the wireless operator forwards the SMS message to the user's mobile phone/handset in step 230. If the user replies “Yes” in step 235, then the wireless operator forwards the SMS message with the “Yes” response to the SMS aggregator in step 240, and the SMS aggregator forwards the SMS message to the Virtual Ticketing Platform 110 in step 245. In step 250, the Virtual Ticket Platform 110 tentatively places an entry for the user in the virtual ticket line or queue, and sends a Premium SMS (PSMS) message to the SMS aggregator to charge the user for the virtual ticket purchase through his/her mobile carrier. The SMS aggregator forwards the PSMS message to the wireless operator in step 260. The wireless operator charges the user for the virtual ticket purchase based on the PSMS message, and forwards the PSMS message to the user's mobile phone/handset instep 265. This way, the user is charged for the virtual ticket purchase through his/her mobile carrier. In step 270, the wireless operator sends a delivery report of the PSMS to the SMS aggregator that the user has been charged. In step 275, the SMS aggregator informs the Virtual Ticketing Platform 110 to complete the entry for the user in the virtual line or queue.

3. Allocate Real Ticket

On the allocation date and time, the Mobile Virtual Ticketing Platform 110 runs a tool to allocate the real tickets among the users in the virtual line or queue based on the allocation policy that was chosen.

In addition to the users that are chosen by the allocation tool to receive the real tickets, a set of users may be chosen to be on an ordered waiting list. Users on the waiting list are eligible to get the real tickets in case a user who has been allocated a real ticket(s) does not fulfill his/her purchase of the real ticket(s).

For each virtual line entry that is allocated a real ticket, a fulfillment code is created. The fulfillment code may be an alphanumeric code of 6 to 10 digits. All of the valid fulfillment codes are uploaded into the Real Ticket Platform 115. A user who has been allocated a real ticket(s) uses his/her fulfillment code to purchase the real ticket(s), as explained further below.

4. Notify the Purchaser of Ticket Availability

Once the real tickets are allocated, an SMS message is sent to a user's mobile device announcing the allocation of real ticket to the user and giving him/her a specific time limit to complete the fulfillment process. The specific fulfillment code for the user is sent to user, and is used by the user to complete the fulfillment process.

5. Fulfillment Process

The fulfillment process may be based on either a phone or a web interface and may follow the ticketing process the distributor has set up.

For example, the user may access the distributor's web site, enter in the fulfillment code he/she received, enter in his/her payment information (e.g. credit card, PayPal), choose seats and complete the purchase of the real ticket.

If the purchase is not done by the time indicated, then the use of the fulfillment code sent to the user expires and the ticket is allocated to the next registrant in the waiting line. The Real Ticketing Platform 115 may optionally send reminders to the user as the expiry date nears to remind the user to complete the fulfillment process to purchase the ticket or else lose the right to buy the real ticket. This reminder notification may be sent to the user using a SMS message.

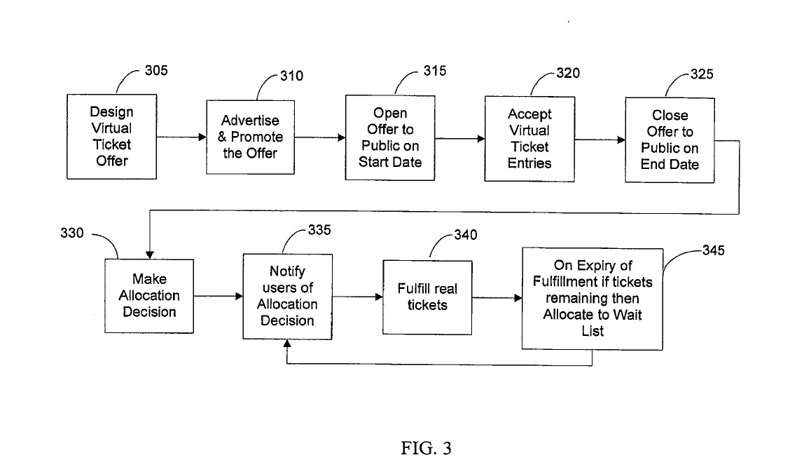

FIG. 3 shows a flowchart of a virtual ticketing process according to an embodiment of the present invention. In step 305, the ticket distributor designs a virtual ticket offer. Designing the offer may include determining how many real tickets for the event will be made available through virtual ticketing, and determining which allocation policy to use. In step 310, the offer is advertised and promoted, e.g., poster, web banner ads, etc. In step 315, the offer is opened to the public on the start time. In step 320, the virtual ticket entries are accepted from users, who are entered into the virtual line or queue by purchasing a virtual ticket. In step 325, the offer is closed to the public on the end date. In step 330, the real tickets are allocated to the user in the virtual line based on the chosen allocation policy. In step 335, users are notified of the allocation decision, and users who have been allocated real tickets are given an opportunity to purchase the real tickets. In step 340, users who have been allocated real tickets fulfill purchases of the real tickets. When the fulfillment period expires in step 345, the remaining real tickets are allocated to users on the wait list, and these user are notified of the allocation in step 335.

Although the present invention has been described in terms of the presently preferred embodiments, it is to be understood that the disclosure is not to be interpreted as limiting. Various alterations and modifications will no doubt become apparent to those skilled in the art after having read this disclosure. Accordingly, it is intended that the appended claims be interpreted as covering all alterations and modifications as fall within the spirit and scope of the invention.

1. A method for distributing tickets to an event, comprising:
enabling customers to be placed in a queue for tickets to the event;
placing a customer in the queue when the customer purchases an entry into the queue;
allocating the tickets to customers in the queue based on an allocation policy; and
giving each customer that has been allocated a ticket an opportunity to purchase the ticket within a time period.

2. The method of claim 1, further comprising enabling the customer to purchase the entry into the queue through a mobile phone.

3. The method of claim 2, further comprising charging the customer for the entry into the queue through a mobile carrier of the customer, wherein the mobile carrier bills the customer for the purchase.

4. The method of claim 1, wherein the allocation policy is on a first come first served basis, in which the tickets are allocated based on an order in which entries are received from the customers.

5. The method of claim 1, wherein the allocation policy is based on a random selection of entries in the queue, in which each customer having a selected entry is given an opportunity to purchase the ticket.

6. The method of claim 5, wherein each entry is associated with a mobile number of the corresponding customer.

7. The method of claim 6, further comprising allowing only one entry per mobile number.

8. The method of claim 6, further comprising allowing multiple entries per mobile number.

9. The method of claim 1, further comprising:
enabling customers in the queue to place bids on the tickets;
ordering the bids from highest bid to lowest bid; and
allocating the tickets to the customers in the queue based on the order of the bids.

10. The method of claim 9, further comprising notifying a customer when the customer's bid is not high enough to receive a ticket.

11. The method of claim 1, further comprising:
placing customers that have not been allocated a ticket in a wait list; and
when a customer that has been allocated a ticket fails to purchase the ticket within the time period, allocating the ticket to a customer in the wait list.

12. The method of claim 1, further comprising providing each customer that has been allocated a ticket a fulfillment code to purchase the ticket.

13. The method of claim 12, wherein the fulfillment code comprises an alphanumeric code.

14. The method of claim 13, further comprising enabling customers that have been allocated a ticket to purchase the ticket through a mobile site using the corresponding fulfillment code.

15. The method of claim 14, wherein the mobile site comprises a Wireless Application Protocol (WAP) site.

16. The method of claim 13, further comprising enabling customers that have been allocated a ticket to purchase the ticket through a web site using the corresponding fulfillment code.
